(19) United States
(12) Patent Application Publication
(10) Pub. No.: US 2004/0104816 A1
(43) Pub. Date: Jun. 3, 2004

(54) Tachometer redline display

(75) Inventor: Mark A. Wilson, Oxford, MI (US)

Correspondence Address: Daimler Chrysler Intellectual Capital Corporation, Daimler Chrysler Technology Center, 800 Chrysler Drive East - CIMS 483-02-19, Auburn hills, MI, 48326-2757, US

(73) Assignee: DaimlerChrysler Corporation

(21) Appl. No.: 10/307,322

(22) Filed: Dec. 2, 2002

(51) Int. Cl. B60Q 1/00

(52) U.S. Cl. 340/438

(57) ABSTRACT

A tachometer redline display system having separately controllable sections for illuminating one or more of the sections from a removable outside programmable source. The selection of particular ones of the illumination portions allows for construction of a tachometer display device usable with all types of engines. Different redline requirements for different engines are taken into account by the number of illumination portions being turned on in response to the outside programmable source to provide improved efficiency in production and a streamlining of vehicle assembly lines containing tachometers.

### BACKGROUND AND SUMMARY OF THE INVENTION

The present invention is addressed to an improved Tachometer Display which allows flexible adjustment of the redline area.

An automobile assembly line uses hundreds of parts which are manufactured offsite by outside suppliers. Any part which can be manufactured for use in a plurality of different vehicle provides an obvious reduction in production costs and an increase in the streamlining of the assembly process. However, due to various requirements of different models of automobile having, as an example, different engine, it is not often possible for one piece of equipment to be used in all vehicles. Very often information and safety display devices including speedometer display, oil pressure gages, and temperature gages are universal for most automobile engine construction. On the other hand, while a Tachometer Display of RPM (revolutions per minute) can be universal for all engines being used by a particular manufacturer, there is a difficulty that the so called “redline” is not the same for all engines.

A redline is the line which indicate a crossing point for the number of RPMs to which the engine is being revved. Anything above the “redline” indicates an excessive strain on the engine and should be avoided. The redline in analogue Tachometer displays is a redband portion beginning at the “redline” and extending to the upper end of the RPM display.

Therefore, because the maximum operating speed of one particular engine may be different than another engine having different characteristics, the redline area will vary between different engines thus requiring a separate manufacture of the tachometer display for each kind of engine available in certain automobiles. In fact, one model of an automobile may have two or three different kinds of engines so that even within one model, two or three different tachometer displays must be used.

It is an object of the present invention to create a redline tachometer display which is universal for all types of engines.

The present invention accomplishes this objective by an assembly tachometer display having a variable redline area wherein the variation of the redline area is programmable by a standard automobile electronic diagnostic computer interface of the type normally used in today's production vehicles.

Other objects, advantages and novel features of the present invention will become apparent from the following detailed description of the invention when considered in conjunction with the accompany drawings.

### BRIEF DESCRIPTION OF THE DRAWINGS

FIGS. 1A-1C show similar tachometer displays having three different redline areas.

FIG. 2 illustrates an electroluminescent lighting (EL) implementation of the tachometer display in the FIGS. 1A-C;

FIG. 2A shows the connection of a remote diagnostic tool to a bus board and control system of an automobile; and

FIGS. 3 and 3A illustrate the lighting implementation and connection of a remote diagnostic tool to a bus board and control system according to an LED embodiment of the tachometer display construction.

### DETAILED DESCRIPTION OF PREFERRED EMBODIMENTS

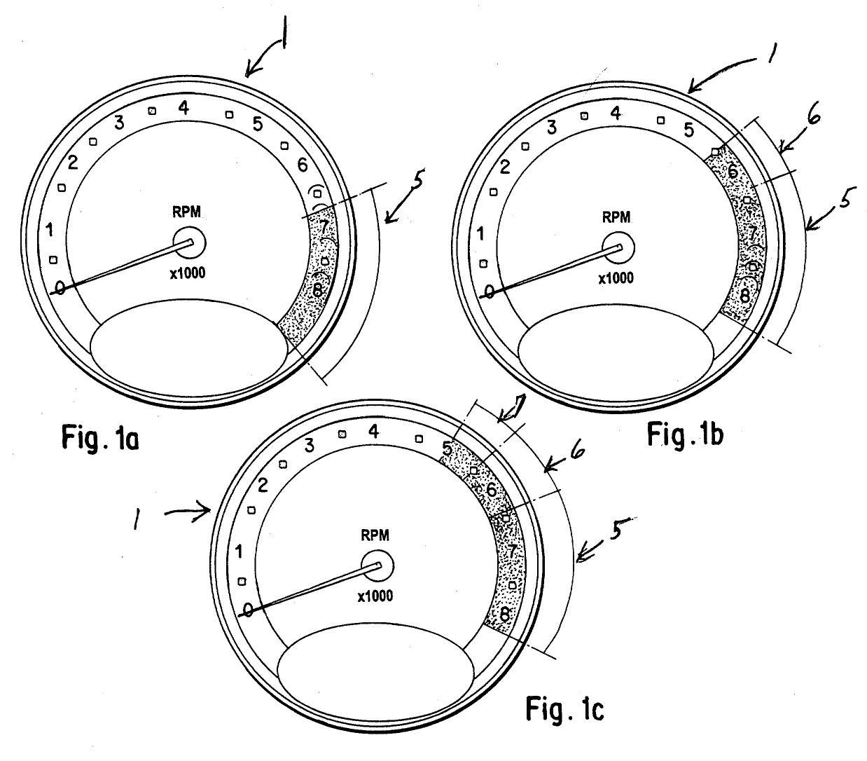

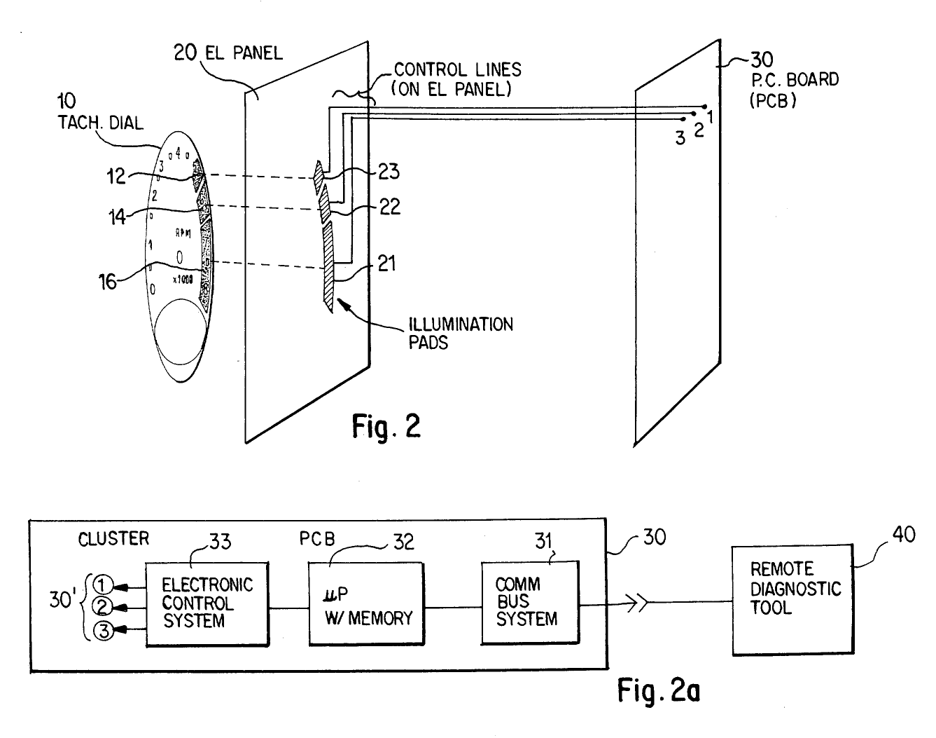

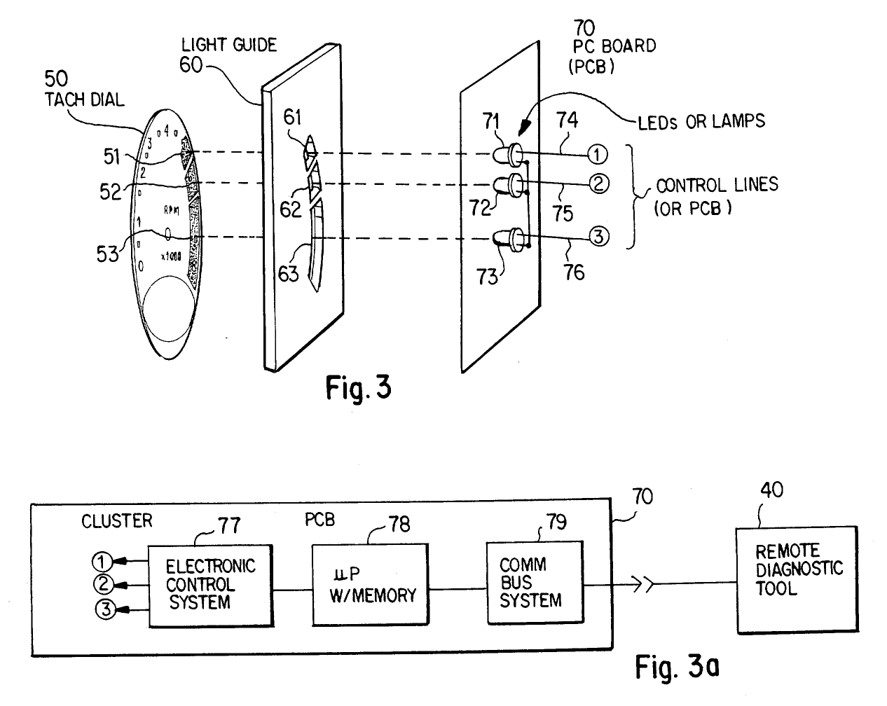

The front face sections of tachometer dial 1 shown in FIGS. 1A-C are, in fact, the same dial having three sections 5-7 which are optionally able to display respective areas of the redline. FIG. 1A shows the use of one section 5 while FIGS. 2 and 3 represent respectively the use of two sections 5 and 6 and three sections 5, 6, and 7.

The construction of the elements of the tachometer display shown are first embodiment in FIG. 2 wherein the tachometer dial 10 is positioned in front of an electro-luminescent panel 20 backed by, in turn, a PC board 30. The electro-luminescent panel has three illumination pads 21-23 connected by way of respective control lines to connections 35 labeled as 1-3 on the PC board 30. Control of electrical signals to individual ones of the contacts 35 provides illumination of pads 21-23.

The PC board 30 electronic is illustrated in FIG. 2A, as having a communication bus system 31. The communication bus system can be, for example, a CAN (Controller Area Network) system. The output of the bus system is fed to the automobile microprocessor 32 which, in turn, enables electronic control system 33 to turn on one or more of the pads 21-23 through the contacts 35. Ultimate signaling as to which of the pads to illuminate is programmed by the remote diagnostic tool 40 which, during production of an automobile can be positioned at the end of the assembly line where all of the control functions are programmed into the computer for that particular automobile. The remote diagnostic tool 40 is also available for the automobile once it is sold in order to make changes to or to test the diagnostics of the system. However, it is not contemplated that once the redline display on the tachometer dial has been appropriately set, there would be any need to make the change because the selection of the particular number of pads 21-23 are a reflection of the particular engine in the automobile. Pads 21-23 are electro-luminescent display areas (EL).

FIG. 3 is another implementation of the lighting of the tachometer dial shown as 50. The particular illustrated embodiment uses light emitting diodes on the PC board 70 which are labeled as dial 71-73 wherein light from these diodes is fed through the light guide 60 onto the areas 51-53 of the tachometer dial 50. FIG. 3A is similar to FIG. 2A and illustrates how a PC board 70 contains an electronic control system 77, microprocessor 78 and communication bus interface system 79 controlled by the remote diagnostic tool 40.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An automobile information display system, comprising:
a front information display area having a plurality of indicia;
a plurality of overlay portions covering a portion of said plurality of indicia;
a plurality of illuminating portions corresponding to said plurality of overlap portions wherein each of said plurality of illuminating portions has a respective input; and
a control device for outputting signals to said respective input of each of said illumination portions to controllably turn on at least one of said plurality of illumination portions.

2. The system according to claim 1, wherein said illumination portions are electro-luminescent display elements.

3. The system according to claim 1, wherein said control device includes a microprocessor and a communication bus interface and wherein an input to said communication bus interface is removable connected to a programmable device for communicating with said control device.

4. The system according to claim 1, wherein said front information display area is a face area of a tachometer display.

5. The system according to claim 1, wherein said display system is a tachometer display system.

6. The system according to claim 1, wherein said illumination portions are turned on by said control device as a function of the type of engine to which said display system will be connected.

7. The system according to claim 1, wherein said illumination portions are formed by light emitting diodes on a board containing said control device.
